(19) United States
(12) Patent Application Publication
(10) Pub. No.: US 2004/0181777 A1
(43) Pub. Date: Sep. 16, 2004

(54) METHOD AND DEVICE FOR PROGRAMMING ELECTRONIC DEVICES USING A UNIFORM PARAMETER FORMAT

(76) Inventor: Swee-Koon Fam, Sandiago, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/249,082

(22) Filed: Mar. 14, 2003

(51) Int. Cl. G06F 9/44

(52) U.S. Cl. 717/114

(57) ABSTRACT

14A method includes providing an executable code that is executable on a series of mobile phone models, and loading the executable code into a memory of a selected mobile phone. The method further includes providing a plurality of parameter sets having a uniform data format, each parameter set corresponding to at least one mobile phone, and then, determining the parameter set corresponding to the selected mobile phone. The method finally includes loading the selected parameter set into the memory of the selected mobile phone. According to the method, the executable code and the selected parameter set combined form operational program code of the selected mobile phone.

### BACKGROUND OF INVENTION

1. Field of the Invention

The present invention relates to digital electronics, and more specifically, to a method and device for programming electronic devices such as mobile phones and personal digital assistants (PDAs).

2. Description of the Prior Art

Portable electronic devices, such as mobile phones and PDAs, require operating software for controlling device hardware to properly realize device functionality. Such software programs provide operating procedures, user interfaces, operating systems, and specialized applications to the hardware of a portable device.

A typical program includes settings or parameters for configuring specific functionality of a device. For example, a program that controls a packet length of a digital transmission will have one or more settings relating a packet length value. In conventional practice, these settings are hard coded into the program, as direct inclusion of user nonadjustable values can provide for smaller and more efficient code. However, including such settings in the program code hinders upgradability and compatibility of the portable device software.

Upgradability and compatibility problems are further caused by rapid changes in portable device hardware versions. A conventional solution to this is labeling software revisions with a version identification number. Then, when a program is to be loaded onto a portable device, the hardware version is checked and a correct software version is selected. If an earlier version of a program is used as a substitute for a new portable device, there is certainly no guarantee that it will function correctly. While an earlier version may indeed work if hardware changes between versions were minimal, added functionality of the new device may not be fully realized. Furthermore, forward compatibility cannot be as easily ensured, and requires long term planning of a portable device product line taking into account redundancy and human error. The drawbacks of loading incorrect program code into a portable electronic device may not cause immediate operational failure of the device, a less apparent degradation of operation taking weeks or months to detect and rectify may instead take place.

In the prior art, loading a new portable device with operating software beings with compiling a new version of the software compatible with the portable device and making a single executable image. The image is then loaded into a memory of the portable device. For example, suppose between a first and second model of a mobile phone, an antenna transmission power level is changed. The program for controlling transmission of radio signals originally written for the first model must then be modified to function on the second model. This requires a programmer to modify or rewrite the associated code and to recompile the image file, all with the possibility of introducing a new error into otherwise error free code. Thus, an entire program image file must be updated for a relatively small change in functionality.

The prior art method of providing software to a portable electronic device is inefficient, and requires rewriting and recompilation of program code.

### SUMMARY OF INVENTION

It is therefore a primary objective of the present invention to provide a method and device for programming electronic devices that employ a uniform parameter format to reduce software-based failures, simplify upgradability, and improve troubleshooting of such electronic devices.

Briefly summarized, a method according to the present invention includes providing an executable code comprising commands executable by a processor of each electronic device of a plurality of electronic devices, and loading the executable code into a memory of a selected electronic device of the plurality of electronic devices. The method further includes providing a plurality of parameter sets having a uniform data format, each parameter set corresponding to at least one electronic device of the plurality of electronic devices, then, determining the parameter set corresponding to the selected electronic device, and finally, loading the selected parameter set into the memory of the selected electronic device. According to the method, the executable code and the selected parameter set combined form operational program code of the selected electronic device.

According to the present invention, a computer system includes a mass storage device, an executable code and a plurality of parameter sets stored in the mass storage device, a port for connecting the mass storage device to a memory of a selected electronic device, and a processor for controlling the mass storage device to transfer the executable code or the corresponding parameter set through the port to the selected electronic device. The executable code is executable on a plurality of different electronic devices, each parameter set corresponds to at least one electronic device, and the executable code and a parameter set combine to form operational program code of the corresponding electronic device.

According to the present invention, each parameter set of the plurality of parameter sets is a subset of a master parameter set, and the master parameter set can be filtered according to the corresponding electronic device to generate the selected parameter set.

It is an advantage of the present invention that the portable executable code and the plurality of parameter sets in accordance with the uniform data format provide for efficient loading of operational program code to various models of electronic device.

It is a further advantage of the present invention that the plurality of parameter sets allow for simplified upgrading and troubleshooting procedures among various models of electronic device.

It is a further advantage of the present invention that the master parameter set saves storage capacity and maximizes processing efficiency of the computer system.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a computer system according to the present invention.

FIG. 2 is a table of sample parameter values of parameter sets shown in FIG. 1.

FIG. 3 is a schematic diagram of a master parameter set and parameter subsets according to the present invention.

FIG. 4 is a flowchart of a method of loading an operational program into a programmable electronic device according to the present invention.

### DETAILED DESCRIPTION

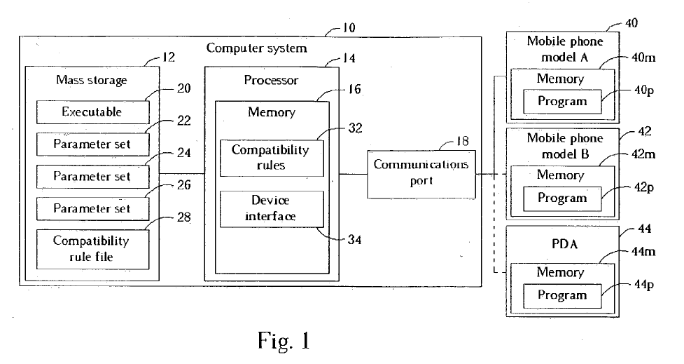

Please refer to FIG. 1 showing a computer system 10 according to the present invention. The computer system 10 includes a mass storage device 12 such as a hard drive or a random-access memory. The computer system 10 further includes a processor 14 connected to the mass storage device 12, the processor 14 and having a supporting random-access memory 16. Further included is a communications port 18 that allows the processor 14 to communicate with an externally connected electronic device. FIG. 1 also illustrates three such electronic devices that can be connected to the computer system 10 through the port 18. Two mobile phones, an “A” model 40 (shown connected to the port 18) and a “B” model 42, and a personal digital assistant (PDA) 44 all respectively include a digital memory 40m, 42m, 44m such as a flash memory or other random-access memory. The processor 14 is capable of communicating data between the mass storage device 12 and an electronic device to be programmed via the communications port 18, and each device can be connected to the port 18 in turn to receive programming.

The mass storage device 12 stores common executable code 20 of a program executable on each of the devices 40,42, and 44. Further provided in the mass storage device 12 are parameter sets 22, 24, and 26 corresponding to the mobile phones 40, 42 and the PDA 44 respectively. The parameter sets 22, 24, and 26 can be merged with the executable code 20 to form operational programs 40p, 42p, and 44p that can be transferred to and stored in the devices 40, 42, and 44 respectively. For instance, the program 40p made by compiling the common executable code 20 with the parameter set 22 can be installed on the model “A” mobile phone 40 to provide functionality to the mobile phone 40 such as antenna calibration, voice/data transmission, or general operating systems. The mass storage device 12 further includes a compatibility rule file 28 correlating each of the electronic devices 40, 42, and 44 to be programmed with parameter sets 22, 24, and 26, the compatibility rule file 28 being a database or similar relationship file.

The processor manages data flow between the mass storage device 12 and the electronic devices 40, 42, and 44. The processor 14 is capable of generating compatibility rules 32 from the compatibility rule file 28, and storing the compatibility rules 32 in the memory 16. The processor 14 can detect a model or hardware version of a connected device and reference the compatibility rules 32 to verify compatibility of a given parameter set and the connected device. The memory 16 of the processor 14 further stores a device interface system 34 for allowing the processor 14 to construct and write a memory image file to a memory of an externally connected electronic device, and to further read image files from the connected device. The device interface system 34 includes well-known utilities for managing, reading, and writing memory images to electronic devices such as a constructor, a writer, and a reader.

As mentioned, the executable code 20 is functional on both the mobile phones 40, 42, and further on the PDA 44. While in practical application relatively few programs are designed to operate on both mobile phones and PDAs, the executable code 20 as described provides a suitable universal application, such as a text entry program, as an example. In other embodiments, the executable code 20 could provide a full mobile phone operating system to a large series of mobile phone models, or a business application to a series of PDAs. The executable code 20 can be built by the processor 14 from source files, include files, and miscellaneous symbolic data files in a manner that is well known in the art.

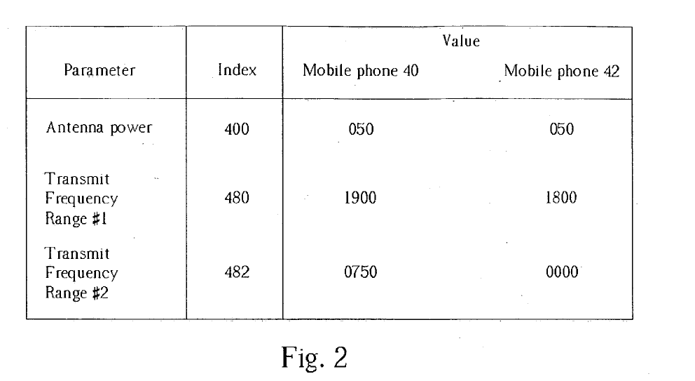

The parameter sets 22, 24, and 26 are established following a uniform data format, and each parameter set 22, 24, and 26 includes parameter values relevant to the respective device 40, 42, 44. If a particular parameter is not used in a particular device, the parameter is excluded from the parameter set or included with a null value. The uniform data format universally stipulates parameter indices for parameter locations within the executable code 20, data formats, and data lengths to ensure compatibility for all parameters used. An example of parameter data is shown in FIG. 2, which shows several parameter values for the mobile phones 40, 42. In the example, antenna power is given an index of “400λ and a value of “050” that is common to both models of phone. However, first transmit frequency ranges at index “480” differ slightly, the mobile phone 40 having a frequency range of 1900 Hz and the mobile phone 42 having a frequency range of 1800 Hz. Moreover, the mobile phone 40 supports a second transmit frequency range of “0750” while the mobile phone 42 does not. In FIG. 2 the uniform data format is apparent in that between the mobile phones 40, 42 all values shown have identical data lengths (3 or 4 digits) as well as common units (Hertz, mW, etc) and format (integer values).

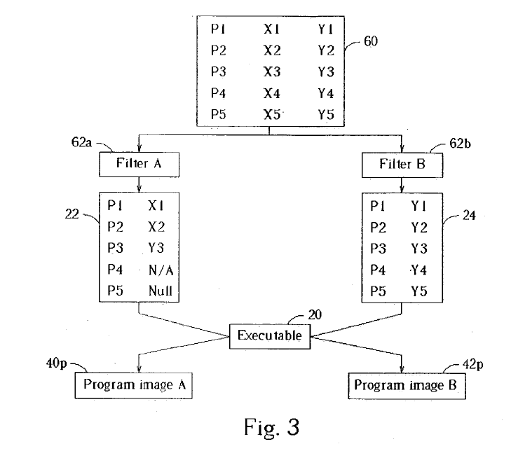

For efficiency, the parameter sets 22, 24, 26, and others can be generated by filtering an established master parameter set. Referring to FIG. 3, a master parameter set 60 and filters 62a and 62b (two shown for example) can be stored in the mass storage device 12. The master parameter set 60 contains all parameters for all supported electronic devices 40, 42, 44, as well as others and all usable values of these parameters. The filters 62a, 62b correspond to mobile phones 40, 42 respectively. The processor 14 is capable of applying each filter 62a, 62b to generate the parameter sets 22, 24, and further merging the parameter sets 22, 24 with the executable code 20 to generate the corresponding program image files 40p, 42p.

In addition, in FIG. 3 examples of parameters P1-P5 and corresponding parameter values X1-X5 and Y1-Y5 according to the uniform data format (X1 and Y1, X2 and Y2, etc having the same data type, data length, and format) are illustrated. The filter 62a generates the parameter set 22 such that P1 and P2 have values of X1 and X2 respectively, parameter P3 has a value of Y3, parameter P4 is not set, and parameter P5 is set to a null value. As mentioned, the executable 20 is programmed to handle unassigned parameters and null values appropriately. The filter 62b generates the parameter set 24 such that all parameters P1-P5 have the corresponding Y1-Y5 values. In this example, the X1-X5 parameters are for an old model mobile phone and the Y1-Y5 parameters are for a newer model. The parameter set 22 is configured for an upgraded version of the old model of phone, where the upgraded hardware supports the new value Y3 for parameter P3 but no longer supports features defined by parameters P4, P5. The parameters P4, P5 are left unassigned or set to null depending on how the executable 20 was originally written. In contrast, the parameter set 24 is used in a newer model phone and therefore can be assigned the entire new parameter set Y1-Y5. This short example illustrates the backward and forward compatibility of the present invention using the same executable code 20.

In operation, the processor 14 first determines the hardware model and software version of the connected electronic device 40, 42, or 44 and references the compatibility rules 32 to determine the appropriate parameter set. If a current or newer parameter set or executable is found on the connected electronic device 40, 42, or 44, the processor 14 terminates programming the device. Otherwise, the processor 14 combines the executable code 20 and a selected parameter set 22, 24, or 26 into the respective program image 40p, 42p, or 44p, and then loads the combined program image 40p, 42p, or 44p into the corresponding device 40, 42, or 44 through the port 18. Alternatively, the processor 14 can load the executable code 20 and the selected parameter set 22, 24, or 26 in two separate operations to increase efficiency and facilitate straightforward upgrading or troubleshooting of the device software.

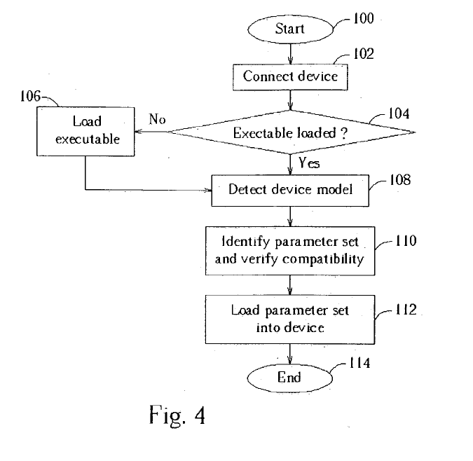

Please refer to FIG. 4 showing a flowchart of a method of loading an operational program into a programmable electronic device. The flowchart depicts a method for separately loading the executable code 20 and a specific parameter set to a selected device, the method being conducive to upgrading the operational program. Referring to the computer system 10 of FIG. 1, the flowchart of FIG. 4 is described as follows.

Step 100:Start;

Step 102:The device to be programmed or updated, the mobile phone 40 for example, is connected to the communications port 18;

Step 104:The processor 14 detects if the memory 40m of the mobile phone 40 has been loaded with the program 40p. If the program 40p is present go to step 108, if not, go to step 106;

Step 106:The processor 14 loads the executable portion 20 of the program 40p into the memory 40m of the mobile phone 40 utilizing the device interface 34;

Step 108:The processor 14 detects the mobile phone 40 hardware model in a way that is well known in the art;

Step 110:Referencing the compatibility rules 32, the processor 14 identifies the parameter set 22 as being suitable for the mobile phone 40. At this time, the processor 14 further checks a version number of a parameter set previously loaded into the mobile phone 40, if any. If the mobile phone 40 already includes the parameter set 22 or another suitable parameter set (such as a newer version of the set 22), the process ends here;

Step 112:The processor 14 loads the parameter set 22 into the memory 40m of the mobile phone 40 through the device interface 34 thereby completing the loading of the operational program 40p;

Step 114:End.

As described above, the computer system 10 can be used to program or update a portable electronic device by first loading the executable 20 and subsequently loading the appropriate parameter set upon verification of the code already present in the electronic device. According to the present invention, the above process is augmented by the uniform data format such that any compatible device can be loaded with the universal executable 20 and further configured with an appropriate parameter set.

In contrast to the prior art, the present invention is capable of loading a universal executable code into a group of different portable electronic devices, and loading a specific parameter set to each of the electronic devices to form operational code for each device. Loading the executable code and a parameter set can be completed simultaneously in one file, as suitable for initially configuring a device; or separately in two successive stages, being conducive to upgrading a device. The present invention is capable of this as the parameter sets follow a uniform data format, each parameter set being interchangeable in the executable code. The present invention method and computer system are more efficient than the prior art, and allow for simplified upgrading and troubleshooting of portable device operational software.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of programming a plurality of different electronic devices with operational program code, each electronic device having a processor and a memory, the method comprising:
providing an executable code comprising commands executable by the processor of each electronic device of the plurality of electronic devices;
loading the executable code into the memory of a selected electronic device of the plurality of electronic devices;
providing a plurality of parameter sets having a uniform data format, each parameter set corresponding to at least one electronic device of the plurality of electronic devices;
determining the parameter set corresponding to the selected electronic device; and
loading the selected parameter set into the memory of the selected electronic device;
wherein the executable code and the selected parameter set combined form the operational program code of the selected electronic device.

2. The method of claim 1 wherein determining the parameter set corresponding to the selected electronic device includes identifying a hardware model of the electronic device and is performed after loading the executable code into the memory of the selected electronic device.

3. The method of claim 1 further comprising merging the executable code and the selected parameter set into a single image file before loading the executable code and the selected parameter set, wherein loading the executable code and the selected parameter set occur substantially simultaneously and comprise loading the single image file.

4. The method of claim 1 further comprising verifying compatibility of the selected parameter set and the selected electronic device before loading the selected parameter set, and loading the selected parameter set only when compatibility is successfully verified.

5. The method of claim 1 wherein each parameter set of the plurality of parameter sets is a subset of a master parameter set.

6. The method of claim 5 wherein when selecting a parameter set, filtering the master parameter set according to selected electronic device to generate the selected parameter set.

7. The method of claim 1 wherein the electronic devices are mobile phones or personal digital assistants (PDAs).

8. A method of programming a plurality of different electronic devices with operational program code, each electronic device having a processor and a memory, the method comprising:
providing an executable code comprising commands executable by the processor of each electronic device of the plurality of electronic devices;
determining if the executable code is present in the memory of a selected electronic device of the plurality of electronic devices;
loading the executable code into the memory of the selected electronic device if the executable code is determined to be not loaded;
providing a plurality of parameter sets having a uniform data format, each parameter set corresponding to at least one electronic device of the plurality of electronic devices;
determining the parameter set corresponding to the selected electronic device, and determining if the selected parameter set is present in the memory of the selected electronic device; and
loading the selected parameter set into the memory of the selected electronic device if the selected parameter set is determined to be not loaded;
wherein the executable code and the selected parameter set combined form the operational program code of the selected electronic device.

9. The method of claim 8 wherein determining the parameter set corresponding to the selected electronic device includes identifying a hardware model of the electronic device and is performed after loading the executable code into the memory of the selected electronic device.

10. The method of claim 8 further comprising merging the executable code and the selected parameter set into a single image file before loading the executable code and the selected parameter set, wherein loading the executable code and the selected parameter set occur substantially simultaneously and comprise loading the single image file.

11. The method of claim 8 further comprising verifying compatibility of the selected parameter set and the selected electronic device before loading the selected parameter set, and loading the selected parameter set only when compatibility is successfully verified.

12. The method of claim 8 wherein each parameter set of the plurality of parameter sets is a subset of a master parameter set.

13. The method of claim 12 wherein when selecting a parameter set, filtering the master parameter set according to the selected electronic device to generate the selected parameter set.

14. The method of claim 8 wherein the electronic devices are mobile phones or personal digital assistants (PDAs).

15. A computer system for programming a plurality of different electronic devices with operational program code, the computer system comprising:
a mass storage device;
an executable code stored in the mass storage device, the executable code executable on the plurality of different electronic devices;
a plurality of parameter sets stored in the mass storage device; wherein each parameter set corresponds to at least one electronic device, and the executable code and a parameter set are capable of being combined to form the operational program code of the corresponding electronic device;
a port for connecting the mass storage device to a memory of a selected electronic device; and
a processor for controlling the mass storage device to transfer the executable code or the corresponding parameter set through the port to the selected electronic device.

16. The computer system of claim 15 further comprising a compatibility rule file stored in the mass storage device, the processor capable of checking compatibility between the selected electronic device and the corresponding parameter set referencing the compatibility rule file.

17. The computer system of claim 15 wherein each parameter set of the plurality of parameter sets is a subset of a master parameter set.

18. The computer system of claim 17 wherein the master parameter set and a plurality of filters for reducing the master parameter set are stored in the mass storage device, and each filter corresponds to at least one electronic device.

19. The method of claim 15 wherein the mass storage device is a hard drive or a random-access memory.

20. The method of claim 15 wherein the electronic devices are mobile phones or personal digital assistants (PDAs).
